(19) United States
(12) Patent Application Publication
(10) Pub. No.: US 2005/0122221 A1
(43) Pub. Date: Jun. 9, 2005

(54) Visible electronic tag and system

(76) Inventors: Hsiang-Kai Chuang, Hsinchu Hsien (TW); Nien-Chu Wu, Hsinchu Hsien (TW)

Correspondence Address: BIRCH STEWART KOLASCH & BIRCH, PO BOX 747, FALLS CHURCH, VA, 22040-0747, US

(21) Appl. No.: 10/790,744

(22) Filed: Mar. 3, 2004

(30) Foreign Application Priority Data
Dec. 9, 2003 (TW) 092134743

(51) Int. Cl. G08B 13/14

(52) U.S. Cl. 340/571; 340/572.8; 340/691.6; 340/5.91; 235/491

(57) ABSTRACT

A visible electronic tag and system aiming at displaying contents stored in the electronic tags mainly has an electronic tag body and a display module. The electronic tag is directly connected to a display module. The reader receives the signals and stores the received information in the electronic tag body. The display module then displays the information without a reader.

### FIELD OF THE INVENTION

The present invention relates to an electronic tag and system adopted for use in stock picking systems, and particularly to a visible electronic tag and a system thereof that is recognizable without using readers.

### BACKGROUND OF THE INVENTION

Electronic tag was originally developed for warehouse management systems. In the past, at least two workers were required to perform warehouse stock-picking due to the complication of the procedures thereof. First, the worker had to search the locations of the merchandises according to a picking list by referring to the package boxes and the stock arrangement map of the warehouse. If stock-picking was performed at night, the dim lights at the warehouse would make the merchandises hard to recognize. Moreover, since one type of goods could be placed at several locations, the possibility of redundant operations increases. Sometimes it was needed to pick up goods repeatedly at a same location. Spreading storing arrangements of the stocks in the warehouse also increases the routines to complete a picking list. Furthermore, since the locations storing the goods could be changed any time, it was difficult for the warehouse workers to remember the exact locations for all kinds of merchandises. As a result, the accuracy to complete a picking list decreases while and the time required to complete a picking list increases.

To remedy the indicated problems, electronic tag has been developed. The electronic tag, which is reusable, is stuck to warehouse racks and linked to a stock picking system so that the instructions and quantities of the merchandises to be picked up at the same rack are displayed simultaneously. However, the electronic tag does not have displaying device thereon. A special reader has to be prepared to read the information contained in the electronic tag.

Due to the fact that a reader is needed to read and confirm the accuracy of the information contained in the electronic tag as well as to make corrections when necessary, extra burdens are actually generated for workers. The reader generally can be divided into two types: stationary and portable. Either one is a necessary equipment to read the information in the electronic tag, which becomes an additional trouble and limits the utilization of the electronic tag. For instance, in a regular supermarket or large super store, product labels are still made by conventional paper or plastics. Once used, they would be replaced and discarded. They do not conform to the environmental conservation concept. It is also not convenient that the labels have to be redone every time changes are needed to be made.

U.S. Pat. No. 6,429,776 discloses a RFID reader with integrated display for use in a product tag system that includes a reader and tags. It employs bar code and has a bar code scanner to directly scan and display the contents of the tag. However, it is still limited to readers and the tag does not have any information for direct identification.

### SUMMARY OF THE INVENTION

In view of the aforesaid disadvantages, the invention aims to provide a visible electronic tag and system that can directly read the content of the electronic tag without a reader.

The visible electronic tag and system according to the invention includes an electronic tag body and a display module. The electronic tag body is directly connected to the display module, as well as to a reader in a wireless fashion. The reader receives the signals and stores the received information in the electronic tag body. The display module then displays the information without a reader. Hence, the applicability of the electronic tag is enhanced significantly.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are schematic views of the system according to the invention.

FIG. 2 is a schematic view of the structure of the invention.

FIG. 3 is a schematic view of another embodiment of the invention.

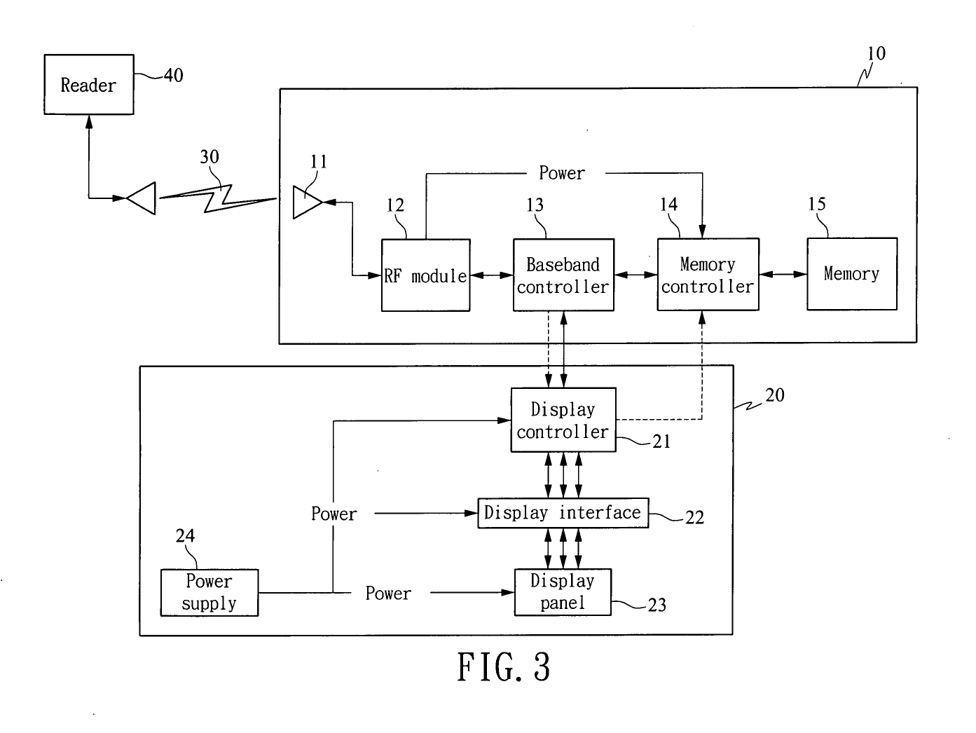

### DESCRIPTION OF THE PREFERRED EMBODIMENTS

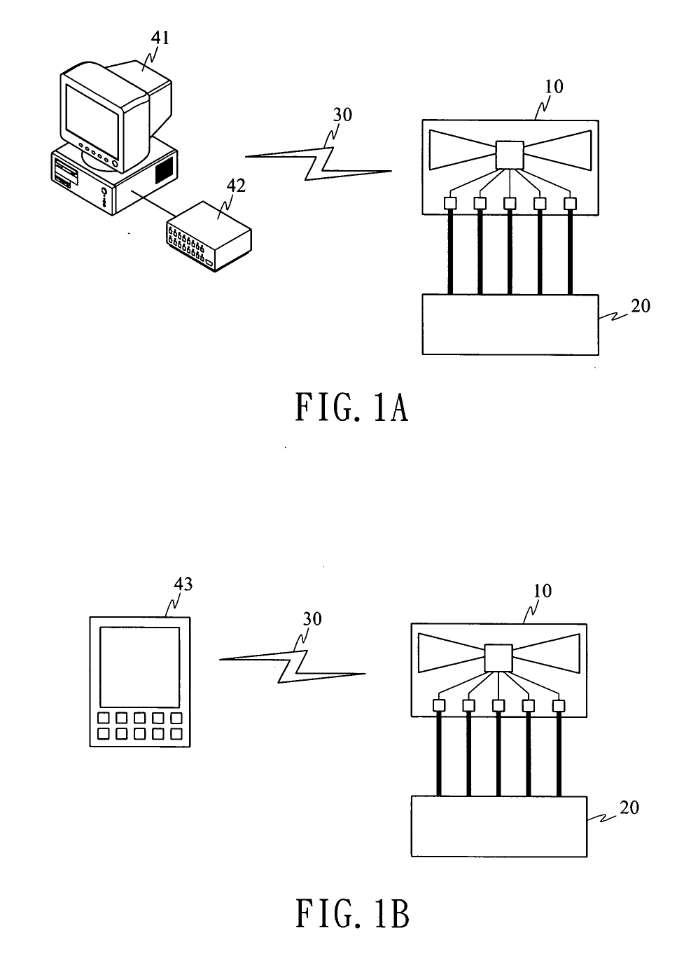

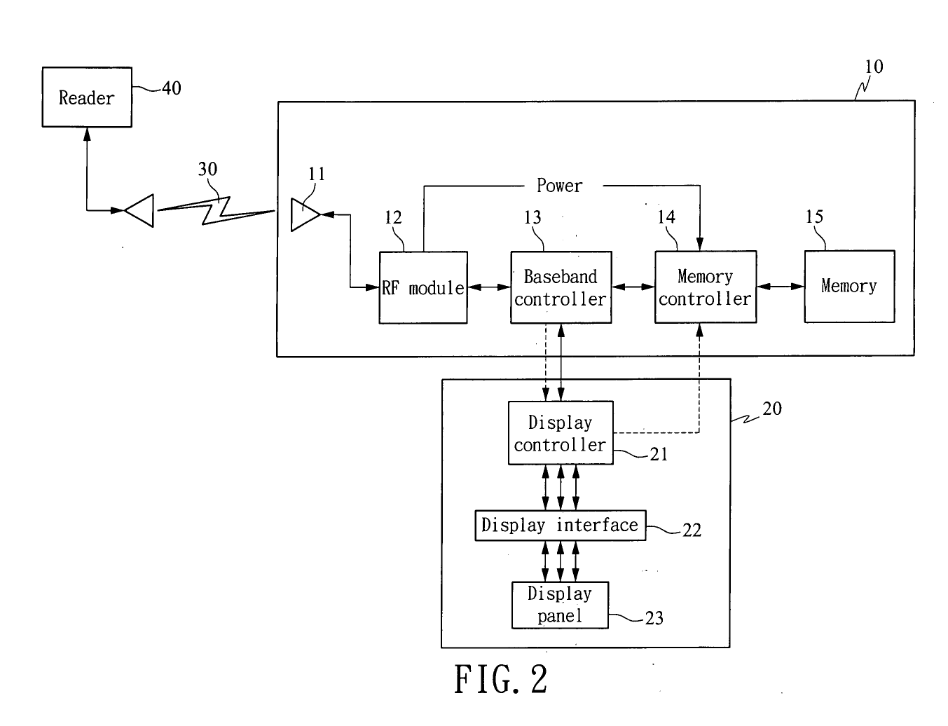

Referring to FIGS. 1 and 2, the visible electronic tag and system according to the invention mainly includes an electronic tag body 10 and a display module 20. The electronic tag body 10 is connected to a reader 40 in a wireless transmission fashion 30 (referring to FIG. 2). The reader 40 may be stationary or portable. The stationary reader includes a stationary electronic device 41 (generally a computer) and a stationary reader 42 (referring to FIG. 1A). The portable reader may be a portable wireless electronic device 43. Either type of the readers transmits signals to the electronic tag body 10 in the wireless transmission fashion 30 for receiving and storing. The display module 20 is directly connected to the electronic tag body 10, and can directly read and display the information in the electronic tag body 10. Hence the information in the electronic tag body 10 can be read and display on the display module 20 without the reader 40. Therefore its applications may be expanded to regular stores for directly displaying merchandise name, price, valid period, special price duration, and the like, which will allow the consumers to directly read the information. Furthermore, field staffs can make the changes through the reader 40 without replacing the tags when needed. The electronic tag not only can replace the conventional labels, its applicability is also expandable.

Refer to FIG. 2 for a structure according to the invention. The electronic tag body 10 includes an antenna 11, a radio frequency module 12, a baseband controller 13, a memory controller 14 and a memory 15. The antenna 11 communicates with the reader 40 in the wireless transmission fashion 30. The radio frequency module 12 controls and modulates the received signals, and transmits them to the baseband controller 13 which transforms the signals and transmits them to the memory 15 for storing through the memory controller 14. For reading data in the memory 15 through the reader 40, the baseband controller 13 reads the data from the memory 15 through the memory controller 14, and transforms and transmits the data to the reader 40 through the radio frequency module 12 and antenna 11 in the wireless transmission approach 30. Electric power required on the memory controller 14 may be provided by the radio frequency module 12.

The display module 20 includes a display controller 21, a display interface 22 and a display panel 23. The display controller 21 is connected to and communicates with the baseband controller 13 of the electronic tag body 10 for retrieving the signals and displaying on the display panel 23 through the display interface 22. The display panel 23 may be a LCD or an electronic paper. There are a lot of choices for the communication between the display controller 21 and the baseband controller 13. For instance, the display controller 21 may directly read the information data in the memory 15 through the baseband controller 13 in a regular time interval; or the baseband controller 13 may initiate signal transmission to the memory controller 14 and the display controller 21 when contents of the memory 15 are to be changed. Meanwhile, the display controller 21 may also directly read the data in the memory 15 through the memory controller 14 by commanding signals.

The electric power required for the display module 20 may also be provided by the radio frequency module 12. Considering the display panel 23 that consumes a greater amount of electric power, an external electric power supply 24 may be added to provide the power needed.

While the preferred embodiments of the invention have been set forth, modifications of the disclosed embodiments of the invention as well as other embodiments thereof may occur to those skilled in the art. Accordingly, the appended claims are intended to cover all embodiments without departing the spirit and scope of the invention.

1. A visible electronic tag, comprising:
an electronic tag body connecting to a reader in a wireless fashion to receive signals transmitted from the reader and store the signals; and
a display module connecting to the electronic tag body to read and display the signals.

2. The visible electronic tag of claim 1, wherein the electronic tag body includes:
an antenna for receiving the signals from the reader;
a radio frequency module connecting to the antenna for processing the signals received by the antenna;
a baseband controller connecting to the radio frequency module to control delivering and receiving of the signals;
a memory controller connecting to the baseband controller for receiving the signals; and
a memory connecting to the memory controller to store the signals.

3. The visible electronic tag of claim 1, wherein the display module includes:
a display controller connecting to the electronic tag body for receiving the signals;
a display interface connecting to the display controller; and
a display panel connecting to the display interface to display the signals.

4. The visible electronic tag of claim 3, wherein the display module further includes an electric power supply to provide electric power required by the display panel.

5. The visible electronic tag of claim 3, wherein the display panel is a liquid crystal display.

6. The visible electronic tag of claim 3, wherein the display panel is an electronic paper.

7. A visible electronic tag system, comprising:
a reader for sending a signal in a wireless fashion;
an electronic tag body connecting to the reader in the wireless fashion to receive the signal transmitted from the reader and store the signal; and
a display module connecting to the electronic tag body to read and display the signal.

8. The visible electronic tag system of claim 7, wherein the electronic tag body includes:
an antenna for receiving the signal from the reader;
a radio frequency module connecting to the antenna for processing the signal received by the antenna;
a baseband controller connecting to the radio frequency module to control delivering and receiving of the signal;
a memory controller connecting to the baseband controller for receiving the signal; and
a memory connecting to the memory controller to store the signal.

9. The visible electronic tag system of claim 7, wherein the display module includes:
a display controller connecting to the electronic tag body for receiving the signal;
a display interface connecting to the display controller; and
a display panel connecting to the display interface to display the signal.

10. The visible electronic tag system of claim 9, wherein the display module further includes an electric power supply to provide electric power required by the display panel.

11. The visible electronic tag system of claim 9, wherein the display panel is a liquid crystal display.

12. The visible electronic tag system of claim 9, wherein the display panel is an electronic paper.

13. The visible electronic tag system of claim 7, wherein the reader is a portable wireless electronic device.

14. The visible electronic tag system of claim 7, wherein the reader is connected to a stationary electronic device.
